(19) United States
(12) Patent Application Publication
(10) Pub. No.: US 2019/0161978 A1
(43) Pub. Date: May 30, 2019

(54) EXTERIOR ENGINEERED WOOD DECK SYSTEM

(71) Applicant: LOUISIANA-PACIFIC CORPORATION, NASHVILLE, TN (US)

(72) Inventors: JOSHUA JACKSON, THOMPSON STATION, TN (US); HEIDI M. TURNER, MURFREESBORO, TN (US); PHILLIP J. VACCA, Jr., NASHVILLE, TN (US); JARROD KEVIN LINE, BRENTWOOD, TN (US); GARETH PAUL MERRICK, GIG HARBOR, WA (US); ASHWIN HIMATSINGANI, BRENTWOOD, TN (US); WILLIAM HOWARD BAIRD, NASHVILLE, TN (US); JIANWEN NI, FRANKLIN, TN (US)

(21) Appl. No.: 16/141,900

(22) Filed: Sep. 25, 2018

Related U.S. Application Data
(60) Provisional application No. 62/562,523, filed on Sep. 25, 2017.
(60) Provisional application No. 62/631,978, filed on Feb. 19, 2018.
(60) Provisional application No. 62/631,983, filed on Feb. 19, 2018.

(51) Int. Cl. E04F 15/04; E04F 15/02; B32B 7/12; B32B 21/13; B32B 21/14

(52) U.S. Cl. CPC E04F 15/045; E04F 15/02183; B32B 2419/00; B32B 21/13; B32B 21/14; B32B 7/12

(57) ABSTRACT

A system for constructing a deck using engineered wood products, including, but not limited to, structural composite lumber (SCL). Deck boards may be formed from a plurality of veneer layers treated with fire protection treatments, preservatives and/or other chemical treatments, which may be specific to a particular veneer layer, and assembled with adhesives binding the layers together in a stack, resulting in a deck board with unique properties in aggregate. The veneer layers directly adjacent to the two outer face layers may be positioned so that the direction of the wood grain is cross-directional to the direction of the wood grain in the surface layers. The boards are also subject to a multi-layer surface finishing treatment with aesthetic components and a protective component.

This application claims benefit of and priority to U.S. Provisional Application No. 62/562,523, filed Sep. 25, 2017, and U.S. Provisional Applications Nos. 62/631,983 and 62/631,978, filed Feb. 19, 2018, all of which are incorporated herein by specific reference for all purposes.

### FIELD OF INVENTION

This invention relates to a system for an exterior deck comprising engineered wood components.

### SUMMARY OF INVENTION

In various exemplary embodiments, the present invention comprises a system for constructing a deck using engineered wood products, including, but not limited to, all forms of structural composite lumber (SCL), oriented-strand lumber (OSL), oriented-strand board (OSB), laminated strand lumber (LSL), laminated veneer lumber (LVL), parallel strand lumber (PSL), laminated veneer bamboo (LVB), plywood, or products with cross-directional wood grains or fibers. In several embodiments the deck boards (and upward facing surfaces of various deck components, such as, but not limited to, stair treads and rail tops) are constructed of a substrate comprising one or more of the engineered wood products described above. In several embodiments, the substrate wood comprises spruce, douglas fir, southern yellow pine, bamboo, or other suitable lignocellulosic wood or fiber material, or combinations thereof. The substrate material is subject to treatment during manufacturing (e.g., addition of adhesives, fire retardants, and/or preservatives), with certain surfaces subject to application of one or more surface treatment system layers, including, but not limited to, a coating layer.

In certain exemplary embodiments, the substrate comprises a plurality of cross-directional layers which are treated with fire retardants/resistant treatments, preservatives and/or weather resistant chemicals, and assembled with adhesives binding the layers together in a stack. Fire protection or resistance treatments include, but are not limited to, combustion resistance, flame spread resistance, and ignition resistance. Preservatives and/or chemical treatments and/or fire retardants/resistant treatments may be added before and/or after assembly of the stack. Additionally, the type of treatment used may be different depending on the layer (e.g. veneer) to take advantage of the type of protection needed (e.g., decay resistance, insect resistance, fire protection, and the like). This results in a targeted, cost effective approach to substrate protection.

In on embodiment, a deck board comprises eight layers of thin wood (e.g., veneers) assembled with adhesives, with some of the veneers stacked cross-directionally compared to the majority of the veneers. In one embodiment, the second and seventh veneer layers (i.e., the veneer layers directly adjacent to the two outer face layers) are positioned so that the direction of the wood grain is cross-directional (i.e., at approximately right angles or 90 degrees) to the direction of the wood grain in the outer face layers (i.e., layers one and eight) and the more interior layers (i.e., layer three through six). It should be noted that a similar cross-directional arrangement could be used with a deck board with a different number of layers, with the veneer layers directly adjacent to the outer face layers (i.e., the “one-in” layers) are positioned cross-directionally. In some embodiments, additional layers of the stack may be positioned cross-directionally, depending on the application. In general, the top and bottom surface layers are not positioned cross-directionally, as this may affect the surface appearance of the board (i.e., the wood grain running across the width of the board rather than running parallel to the length of the board), as well as its overall strength.

The benefits of this form of substrate are substantial. It allows the use of a variety of wood and non-wood species and smaller trees that cannot be used to make large-section solid sawn lumber and beams, with the surface appearance of a complete board with a common direction of wood grain. The resulting board has improved dimensional stability and reduced warping (i.e., maintaining the orthogonality of the boards) with the addition of the cross-directional layers near the surface layers.

Preservatives and/or treatments may be added to the substrate which would normally be more difficult or costly in solid sawn lumber. By treating individual veneers, additives can be added more quickly or at a lower cost than by treating solid sawn lumber. Treatments with various properties can be added at the glue line to provide additional properties. Different substrate layers can have specific treatments distinct for other layers to provide unique properties in aggregate. In one exemplary embodiment, the top veneer can have preservatives and chemicals which impart surface hardness to the veneer, while the bottom veneer is treated with preservatives and fire retardants. The resulting product would be difficult or expensive to produce from solid sawn lumber. In a further embodiment, veneers in different layers could be from different species or the same species cut with different methods. The top veneer, for example, could be provided with a linear cut naturally durable hardwood, while the remaining veneers can be from lower cost rotary peeled wood.

The deck boards and other deck components may further comprise a surface finishing system, including but not limited to an overlay or coating that provides or increases impact resistance, durability, aesthetics, fade protection, and stain resistance, while also covering and protecting joints or seams between veneers in a layer (e.g., where the pieces of veneer in a particular layer, such as the top surface layer, meet), or between layers of veneers (particularly along the sides or ends of a board). Covering these joints/seams also improves the visual appearance of the final product.

In one embodiment, the surface finishing system comprises both an aesthetic component and a protective component, and may be applied to the bottom surface as well as the top surface. In additional embodiments, some or all elements of the surface finishing system may also be applied to the sides and ends of the deck board or component. In one embodiment, the aesthetic component comprises a base layer, which acts a primer or cushion layer which builds the foundation for the rest of the layers of the surface finishing system. The base layer may be opaque. A visually aesthetic layer may then be placed on the base layer. The visually aesthetic layer can be a pre-printed paper layer, or can be printed directly onto to the base layer by means of a printer or printers in the manufacturing line. In one embodiment, high-resolution digital images are printed on the base layer to create a digitally reproduced board with a desired appearance (and, in some embodiments, texture). This can replicate the appearance and/or texture of any material. A protective layer (typically clear or translucent, such as translucent paper or a coating as described below) may then be applied to provide durability, impact resistance, stain and wear resistance, UV/fade resistance, water resistance, and a skid-resistant surface where needed.

In further embodiments, a deck board may have a unique profile in cross-section to wick moisture away from the deck board. In various embodiments, the profile comprises curved edges with a channel or concave indentation extending along the length of each board for hidden fasteners. In the embodiment shown, the width of the flat section of the bottom of the board may be less than the width of the flat section of the top.

Other structural components, including, but not limited to, beams, columns, girders, and joists also may be constructed and protected as described above. Connections between some or all of the above elements may comprise hidden fasteners.

### BRIEF DESCRIPTION OF THE DRAWINGS

FIG. 1 shows a cross-sectional view of a layered deck board.

FIG. 2 shows a profile view of a deck board.

FIGS. 3-6 shows cross-sectional views of alternative embodiments of a layered deck board.

FIG. 7 shows a cross-sectional view of a layered deck board with surface finishing system components.

### DETAILED DESCRIPTION OF EXEMPLARY EMBODIMENTS

In various exemplary embodiments, the present invention comprises a system for constructing a deck using engineered wood products, including, but not limited to, all forms of structural composite lumber (SCL), oriented-strand lumber (OSL), oriented-strand board (OSB), laminated strand lumber (LSL), laminated veneer lumber (LVL), parallel strand lumber (PSL), laminated veneer bamboo (LVB), plywood, or products with cross-directional wood grains or fibers. In several embodiments the deck boards (and upward facing surfaces of various deck components, such as, but not limited to, stair treads and rail tops) are constructed of a substrate comprising one or more of the engineered wood products described above. In several embodiments, the substrate wood comprises spruce, douglas fir, southern yellow pine, bamboo, similar lignocellulosic wood or fiber material, or combinations thereof. The substrate material is subject to treatment during manufacturing (e.g., addition of adhesives, preservatives, and/or fire retardants/resistant treatments), with certain surfaces subject to application of one or more surface treatment system layers, including, but not limited to, a coating layer.

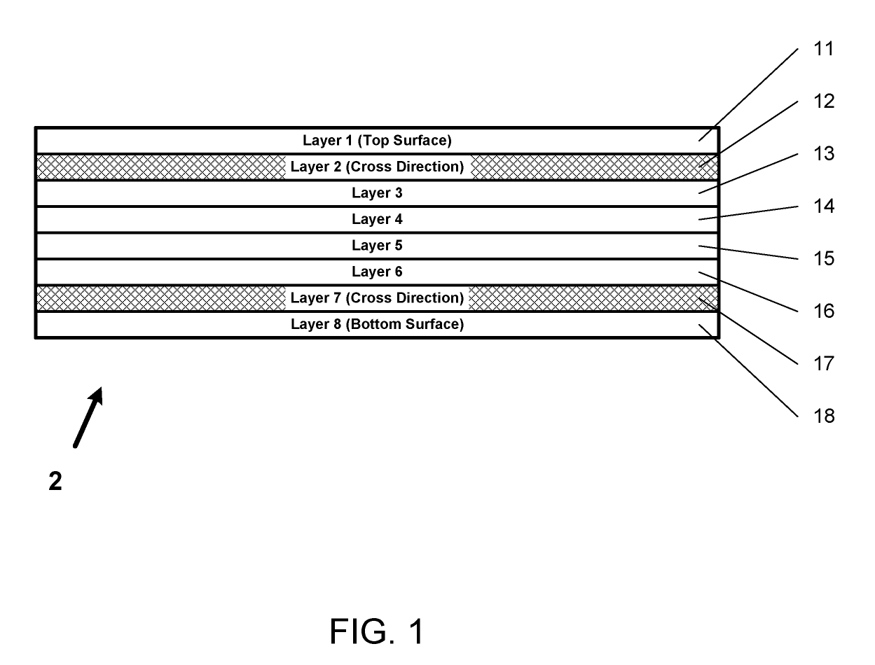

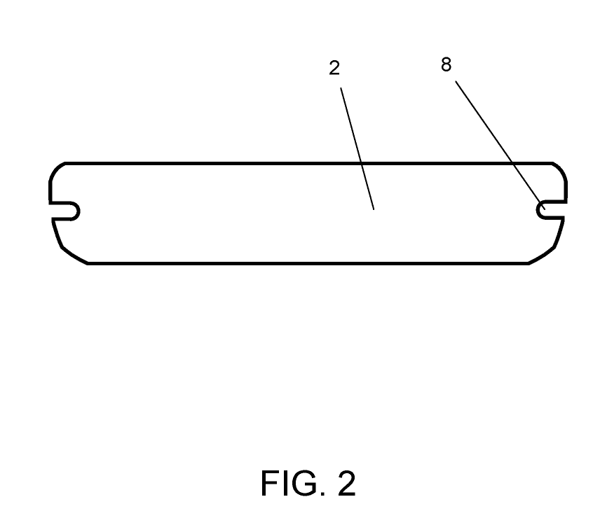

In certain exemplary embodiments, as seen in FIGS. 1 and 3-6, the substrate 2 comprises a plurality of veneer layers (some cross-directional) which are treated with fire retardants/resistant treatments, preservatives and/or weather resistant chemicals, and assembled with adhesives binding the layers together in a stack. Adhesives include, but are not limited to, phenol-formaldehyde (PF) resin. Fire protection or resistance treatments include, but are not limited to, combustion resistance, flame spread resistance, and ignition resistance. Preservatives and/or chemical treatments and/or fire retardants/resistant treatments may be added before and/or after assembly of the stack. Additionally, the type of treatment used may be different depending on the layer (e.g. veneer) to take advantage of the type of protection needed (e.g., decay resistance, insect resistance, fire protection, and the like). This results in a targeted, cost effective approach to substrate protection.

In the embodiment shown in FIG. 1, a deck board comprises eight layers of thin wood (e.g., veneers) assembled with adhesives, with some of the veneer layers stacked cross-directionally compared to the majority of the veneers. In the example shown in FIG. 1, the second 12 and seventh 17 veneer layers (i.e., the veneer layers directly adjacent to the two outer face layers 11, 18) are positioned so that the direction of the wood grain is cross-directional (i.e., at approximately right angles or 90 degrees) to the direction of the wood grain in the outer face layers (i.e., layers one 11 and eight 18) and the more interior or “core” layers (i.e., layer three through six 13-16).

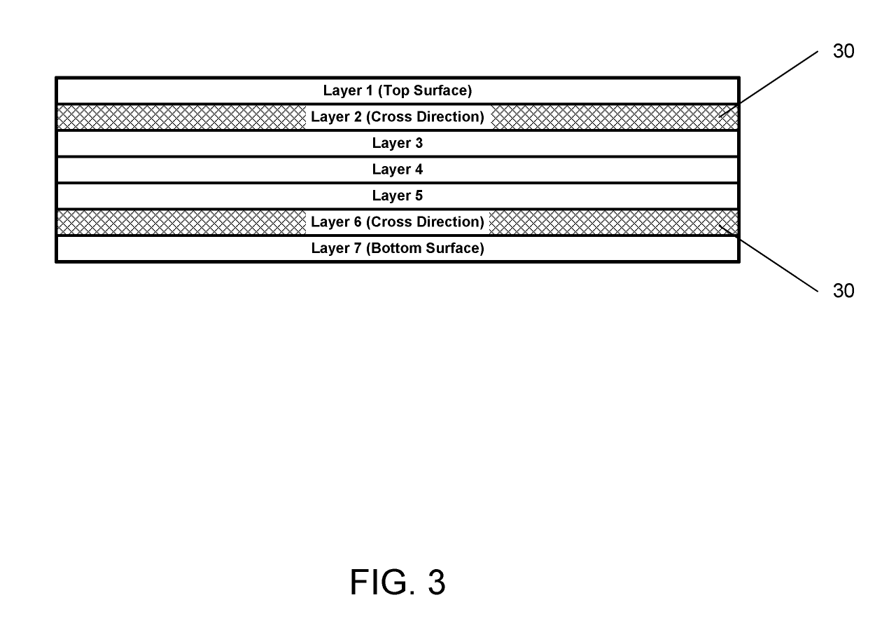

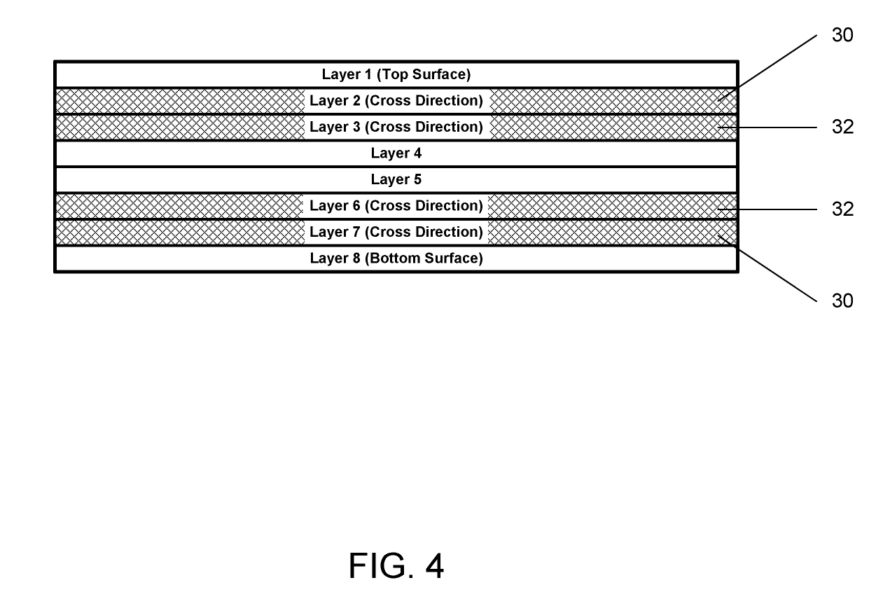

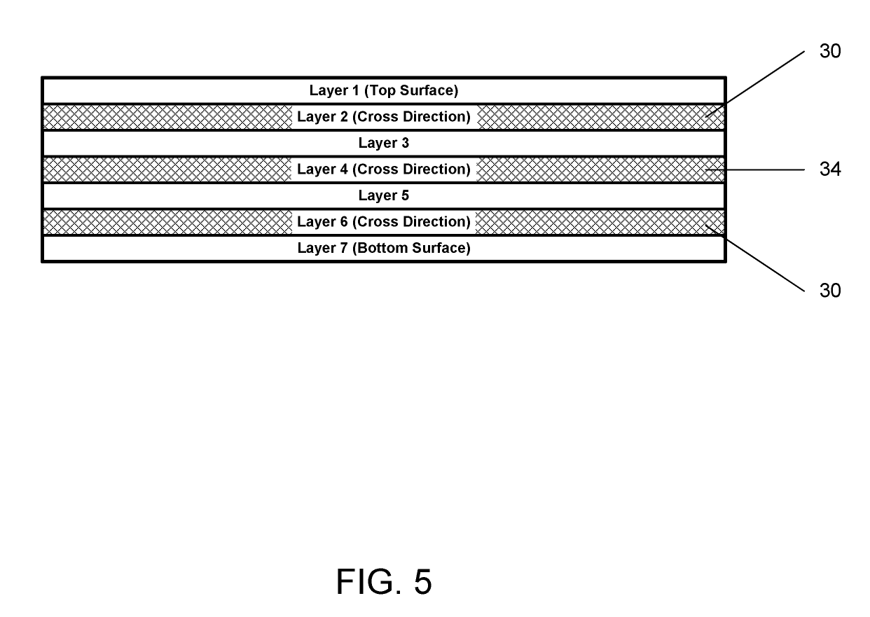

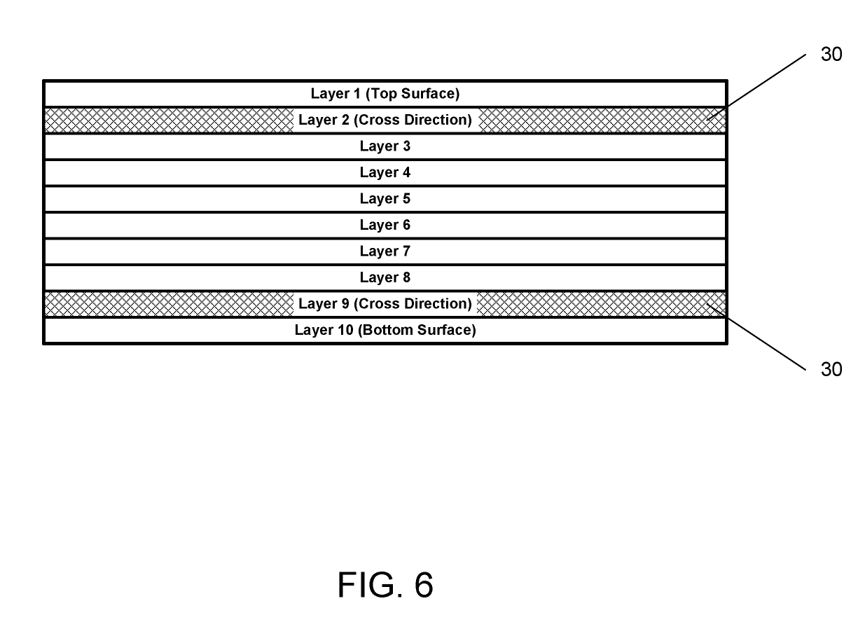

As seen in FIGS. 3 and 6, it should be noted that a similar cross-directional arrangement could be used with a deck board with a different number of layers, with the veneer layers 30 directly adjacent to the outer face layers (i.e., the “one-in” layers) are positioned cross-directionally. In some embodiments, as seen in FIGS. 4 and 5, additional layers 32, 34 of the stack may be positioned cross-directionally, depending on the application. In general, the top and bottom surface layers are not positioned cross-directionally, as this affects the surface appearance of the board (i.e., the wood grain raining across the width of the board rather than running parallel to the length of the board), as well as its overall strength.

The benefits of this form of substrate are substantial. It allows the use of a variety of wood and non-wood species and smaller trees that cannot be used to make large-section solid sawn lumber and beams, with the surface appearance of a complete board with a common direction of wood grain. The resulting board has improved dimensional stability and reduced warping (i.e., maintaining the orthogonality of the boards) with the addition of the cross-directional layers near the surface layers.

Preservatives and/or treatments may be added to the substrate which would normally be more difficult or costly in solid sawn lumber. By treating individual veneers, additives can be added more quickly or at a lower cost than by treating solid sawn lumber. Treatments with various properties can be added at the glue line to provide additional properties. Different substrate layers can have specific treatments distinct for other layers to provide unique properties in aggregate. In one exemplary embodiment, the top veneer can have preservatives and chemicals which impart surface hardness to the veneer, while the bottom veneer is treated with preservatives and fire retardants. The resulting product would be difficult or expensive to produce from solid sawn lumber. In a further embodiment, veneers in different layers could be from different species or the same species cut with different methods. The top veneer, for example, could be provided with a linear cut naturally durable hardwood, while the remaining veneers can be from lower cost rotary peeled wood.

The deck boards and other deck components may further comprise a surface finishing system, including but not limited to an overlay or coating that provides or increases impact resistance, durability, aesthetics, fade protection, and stain resistance, while also covering and protecting joints or seams between veneers in a layer (e.g., where the pieces of veneer in a particular layer, such as the top surface layer, meet), or between layers of veneers (particularly along the sides or ends of a board). Covering these joints/seams also improves the visual appearance of the final product.

In various embodiments, the finished deck board ranges from 0.25 inches to 5.5 inches in thickness. The number of layers or veneers to manufacture a finished deck board depends on the thickness of the layers and the desired thickness of the deck board.

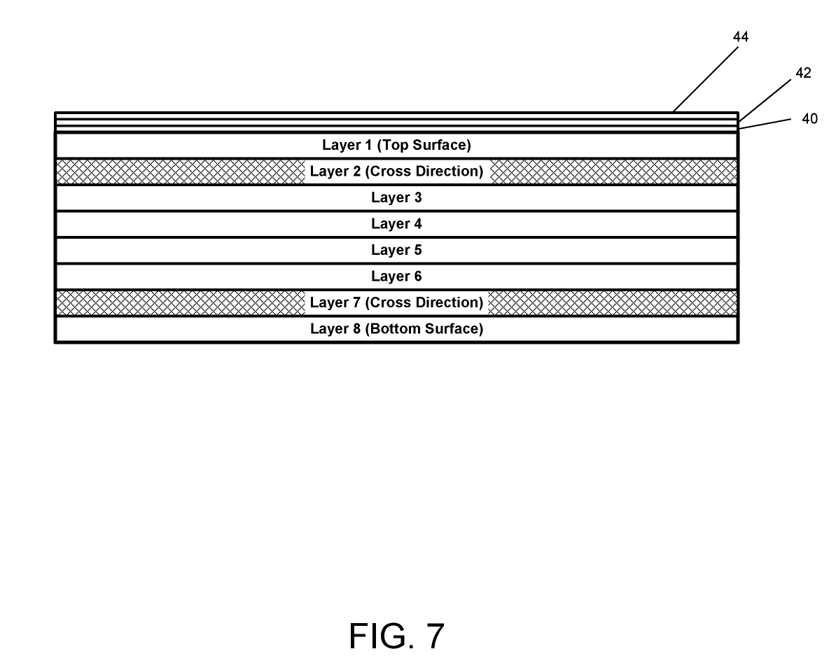

In one embodiment, as seen in FIG. 7, the surface finishing system comprises both an aesthetic component 40, 42 and a protective component 44, and may be applied to the bottom surface as well as the top surface. In additional embodiments, some or all elements of the surface finishing system may also be applied to the sides and ends of the deck board or component. In one embodiment, the aesthetic component comprises one or more base layers 40, which acts a primer or cushion layer which builds the foundation for the rest of the layers of the surface finishing system. The base layer may be opaque. One or more visually aesthetic layers 42 may then be placed on the base layer or layers. The visually aesthetic layer can be a pre-printed paper layer, or can be printed directly onto to the base layer by means of a printer or printers in the manufacturing line, or may be integrated as part of the base layer. In one embodiment, a high-resolution digital image or images are printed on the base layer to create a digitally reproduced board with a desired appearance (and, in some embodiments, texture). This can replicate the appearance and/or texture of any material. One or more protective layers 44 (typically clear or translucent, such as translucent paper or a coating as described below) may then be applied over the base and/or visually aesthetic layers to provide durability, impact resistance, stain and wear resistance, UV/fade resistance, water resistance, and a skid-resistant surface where needed.

In further embodiments, a deck board 2 may have a unique profile in cross-section to wick moisture away from the deck board. In various embodiments, the profile comprises curved edges with a channel or concave indentation 8 extending along the length of each board for hidden fasteners. In the embodiment shown, the width of the flat section of the bottom of the board may be less than the width of the flat section of the top.

Other structural components, including, but not limited to, beams, columns, girders, and joists, also may be constructed and protected as described above. Connections between some or all of the above elements may comprise hidden fasteners.

In several embodiments, the engineered wood of the present invention comprise flake geometry similar to OSB or LSL materials. Preservatives include, but are not limited to, zinc borate, acid copper chromate (ACC), alkaline copper quaternary (ACQ), chromated copper arsenate (CCA), copper azole (CA), creosote, micronized copper, pentachlorophenol, and/or propiconazole (subject to regional requirements and limitations). For example, preservatives may include those that are standardized by the American Wood Protection Association and U.S. EPA labeled for the described end use.

Coatings include, but are not limited to, PVDF (poly(vinylidene fluoride), polyurea, polyester polyurethane, automotive polyurethane, PDMS-co-EPDXY, melamine, PDMS-ether-imide, acrylic, and PVC. Coatings additives may include, but are not limited to, aluminum oxide, silicon oxide or other materials to impart specific properties. In several embodiments, the coating system is HAPs free, with a low VOC level. The coating is bulk water resistant, slip resistant, wear and erosion resistant, UV resistant, color fast, impact resistant (e.g., scratch, pencil, heel marks), and chemical resistant. Coatings are flexible enough to tolerate expansion and contraction due to temperature, humidity and weather fluctuations.

In several embodiments, the coating composition comprises a functional thermoplastic oligomer or polymer, a crosslinker, a catalyst, pigments, additives, and solvent. The functional thermoplastic oligomer or polymer has suitable functionality such as hydroxyl, carboxyl, amino, acetoacetyl, vinyl, epoxy, cyclic carbonate, isocyanates, isothiocyantes, malonates that are capable of undergoing crosslinking reactions via condensation, addition, radical or UV/E beam radiation. Such functional groups are covalently attached to oligomers or polymers with number average molecular weight ranging between 500 grams per mol and 200000 grams per mol such as, but not limited to, fluoropolymers like poly tetrafluoroethylene (PTFE), polyvinylidene fluoride (PVDF), perfluorinated vinyl ether (PEVE), silicones, polyesters, polyethers, polyamides, polyimides, polyether imides, polyether imide silicone copolymer, polybenzimidazole, polybenzoxazole, polythiazole, polyvinyl carbazole, polyolefins, poly cycloolefin copolymers and any mixture thereof.

Examples of the crosslinker include, but are not limited to, polymeric isocyantes, polyaspartic acid, melamine-formaldehyde condensates, urea-formaldehyde condensates, quinidine-formaldehyde condensates, and acrylate terminated oligomer.

Examples of the catalyst include, but are not limited to, (i) a metal catalyst like dibutyl tin dilaurate, or dibutyl tin oxide; (ii) an acid catalyst like p-toluene sulfonic acid; and (iii) a base catalyst like sodium methoxide, sodium benzoate, dicyclo bis (2,2,2) octane, or dibutyl urea.

Examples of pigments include, but are not limited to, oxides of iron, titanium, zirconium, vanadium, chromium, nickel, cobalt and zinc.

Examples of additives include, but are not limited to, (i) dispersing aids such as cationic, non-ionic and anionic surfactants; (ii) flow control agents such as silica; and (ii) slip additives such as coarse sands, ultra-high molecular weight polyolefins.

Examples of solvents include, but are not limited to, water, methyl ethyl ketone, acetone, butyl acetate, dimethyl formamide, dimethyl acetamide and N-methyl pyrrolidone.

Methods of applying the coating or coatings include, but are not limited to, spraying of a liquid coating, or electrostatic coating with powder materials from any of the above-described coating compositions, following by curing using thermal or UV-E beam radiation. Coatings can be made in a separate process and subsequently attached to the treated, layered substrate. This pre-made coating could be, as an example, attached by various methods (e.g. friction fitted, adhesive bonded) to any combination of top, sides, bottom and ends of the substrate.

In several exemplary embodiments, the present invention comprises a manufacturing process to make a layered manufactured wood product usable for decking applications. Veneer sections are peeled from a log, dried, and then treated with preservatives and special formulations and treatments as described above. Veneer layers may receive different treatments. The veneers are re-dried, then laid out (with the immediately adjacent subsurface layers cross-direction to the other layers) with adhesive, and heat pressed to form a billet. The top layer (and possibly the bottom layer) are treated in-line with both the aesthetic component and a protective component/coating of the surface finishing system, as described above, following by finishing processes (e.g., edge treatment). Examples of prior art LVL manufacturing processes are disclosed in Tsuda, U.S. Pat. No. 5,662,760, and Lahtinen, U.S. Pat. No. 4,608,106, which are incorporated herein by specific reference for all purposes.

Thus, it should be understood that the embodiments and examples described herein have been chosen and described in order to best illustrate the principles of the invention and its practical applications to thereby enable one of ordinary skill in the art to best utilize the invention in various embodiments and with various modifications as are suited for particular uses contemplated. Even though specific embodiments of this invention have been described, they are not to be taken as exhaustive. There are several variations that will be apparent to those skilled in the art.

What is claimed is:

1. A deck board for an exterior deck, comprising:
a substrate with a top, bottom, front edge, back edge, first end, and second end, said substrate comprising a plurality of layers adhered to one another;
further wherein one or more of the plurality of layers is treated individually and independently of at least one of the remaining substrate layers prior to formation of the substrate;
further wherein said individual treatment constitutes application of one or more of a preservative, a fire retardant, and a fire protection or resistance treatment.

2. The deck board of claim 1, wherein said fire protection or resistance treatment constitutes one or more of a combustion resistant, flame spread resistant, and ignition resistant treatment.

3. The deck board of claim 1, wherein said individual treatment comprises application of an adhesive.

4. The deck board of claim 1, wherein said plurality of layers comprises a top surface layer, a bottom surface layer, a first subsurface layer immediately adjacent to the top surface layer, a second subsurface layer immediately adjacent to the bottom surface layer, and a plurality of interior layers therebetween.

5. The deck board of claim 4, wherein the first subsurface layer is positioned cross-directionally with respect to the top surface layer.

6. The deck board of claim 4, wherein the first second subsurface layer is positioned cross-directionally with respect to the top surface layer.

7. The deck board of claim 5, wherein each layer has a wood grain orientation, and the wood grain orientation of the first and second surface layers is cross-directionally oriented with the respect to the wood grain orientation of the top surface layer and bottom surface layer.

8. The deck board of claim 1, further comprising one or more aesthetic layers and/or one or more protective layers on the top of the substrate.

9. The deck board of claim 1, further comprising a base layer and a visual aesthetic layer on the top of the substrate, and a protective layer overlaying the base layer and visual aesthetic layer.

10. The deck board of claim 8, further comprising one or more aesthetic layers and/or one or more protective layers on the top of the substrate.

11. The deck board of claim 1, wherein the visual aesthetic layer comprises a digitally printed image or images.
